(19) United States
(12) Patent Application Publication
(10) Pub. No.: US 2008/0162638 A1
(43) Pub. Date: Jul. 3, 2008

(54) ROLE-BASED CHAT

(76) Inventors: Michael Muller, Medford, MA (US); Andrew L. Schirmer, Andover, MA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(21) Appl. No.: 11/617,079

(22) Filed: Dec. 28, 2006

(51) Int. Cl. G06F 15/16

(52) U.S. Cl. 709/205

(57) ABSTRACT

Embodiments of the invention provide a method, system and computer program product for role-based chats. In one embodiment of the invention, a role based chat method can be provided. The method can include dynamically specifying a role in a chat request, resolving an assignment of the role to a collaborator in a data store of roles, and initiating a chat with the collaborator. In one aspect of the embodiment, resolving an assignment of the role to a collaborator can include dynamically retrieving a pre-determined assignment of the collaborator to the role. However, in another aspect of the embodiment, resolving an assignment of the role to a collaborator can include dynamically retrieving a pre-determined assignment of a group of collaborators to the role, and applying a routing or a scheduling rule to the group to select a particular one of the collaborators for assignment to the role.

### BACKGROUND OF THE INVENTION

1. Field of the Invention

The present invention relates to the field of instant messaging and more particularly instant messaging chat session interruption management.

2. Description of the Related Art

Electronic mail, referred to in the art as e-mail, has proven to be the most widely used computing application globally. Though e-mail has been a commercial staple for several decades, due to the explosive popularity and global connectivity of the Internet, e-mail has become the preferred mode of asynchronous communications, regardless of the geographic separation of communicating parties. Today, more e-mails are processed in a single hour than phone calls. Clearly, e-mail as an asynchronous mode of communications has been postured to replace all other modes of communications excepting voice telephony.

In contrast to the asynchronous nature of e-mail, the recent rapid development of the Internet has led to advanced modes of synchronous, real-time collaboration able to fulfill the real-time communicative requirements of the modern computing participant. Using the Internet or a corporate intranet as a backbone, individuals worldwide can converge in real-time in cyberspace to share ideas, documents and images in a manner not previously possible through conventional telephony and video conferencing. To facilitate collaboration over the Internet, a substantial collection of synchronous messaging technologies and protocols have been assembled to effectively deliver audio, video and data over the single data communications medium of the Internet. These synchronous messaging technologies include several, real-time human-to-human collaborative environments such as instant messaging and persistent chat rooms.

In the conventional instant messaging and chat environment, different collaborators can engage in a real-time exchange of messages including text messages, graphical information and even audiovisual information in a common messaging space. The common messaging space can accommodate a pair of conversants to a chat, or multiple conversants to a conference. In some circumstances, the initiation of the chat can be spontaneous upon one conversant recognizing the presence and availability of a partner conversant. In other circumstances, the initiation of the chat can be planned and can even subsist in a calendared event in a calendaring and scheduling system.

For most users, the identity of a chat participant is known a priori to the initiator of a chat. In many instances, the chat can be initiated through a selection of a known chat participant in a buddy list. Notwithstanding, occasionally the identity of a chat participant will not be known prior to the initiation of a chat session. In particular, in some Web based commerce applications, the initiator of a chat with a customer service professional can be initiated through a link in a Web page without knowing the actual identity of the customer service professional. Rather, only a generic role can be presented to the end user in the link. The link in turn can be “hard wired” to the participant known only to the administrator of the commerce application. The hard wired nature of the role, however, provides little flexibility and remains inexorably bound to a specific person absent recoding of the commerce application.

### BRIEF SUMMARY OF THE INVENTION

Embodiments of the invention provide a method, system and computer program product for role-based chats. In one embodiment of the invention, a role based chat method can be provided. The method can include dynamically specifying a role in a chat request, resolving an assignment of the role to a collaborator in a data store of roles, and initiating a chat with the collaborator. In one aspect of the embodiment, resolving an assignment of the role to a collaborator can include dynamically retrieving a pre-determined assignment of the collaborator to the role. However, in another aspect of the embodiment, resolving an assignment of the role to a collaborator can include dynamically retrieving a pre-determined assignment of a group of collaborators to the role, and applying a routing or a scheduling rule to the group to select a particular one of the collaborators for assignment to the role.

Optionally, the method can include inserting the role in a buddy list, and displaying a status for the role in the buddy list. In particular, displaying a status for the role in the buddy list can include displaying a number of collaborators in a group associated with the role who are known to be available for assignment to the role. Also, displaying a status for the role in the buddy list can include displaying an anticipated wait time before a collaborator in a group associated with the role will be available for assignment to the role.

In another embodiment of the invention, a chat data processing system can be provided. The system can include a chat server, a data store of roles configured to store both roles that have been assigned to collaborators registered with the chat server, and roles that have not yet been assigned to collaborators registered with the chat server, and role based chat logic. The logic can include program code enabled to specify a role in a chat request, to resolve an assignment of the role to a collaborator according to the data store of roles, and to request initiation of a chat with the collaborator by the chat server. Role routing rules further can be provided which specify which collaborator in a group of collaborators assigned to a role is to be dynamically assigned to the role. Similarly, role scheduling rules can be provided which specify which collaborator in a group of collaborators assigned to a role is to be dynamically assigned to the role based upon one of a time and date of the chat request.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a chat system user interface configured for role-based chats;

FIG. 2 is a schematic illustration of a chat data processing system configured for role-based chats; and,

FIG. 3 is a flow chart illustrating a process for role-based chats.

### DETAILED DESCRIPTION OF THE INVENTION

Embodiments of the present invention provide a method, system and computer program product for role-based chats in a chat system. In accordance with an embodiment of the present invention, a selection of roles available for introduction into a chat can be established. The roles can be assigned to one or more collaborators in the chat system, or the roles can be left unassigned. Assignment of collaborators to a role can be performed when the role is invited into a chat, or in advance as part of a static configuration. Finally, presence awareness can be applied to the role based upon the assignment of collaborators to the role.

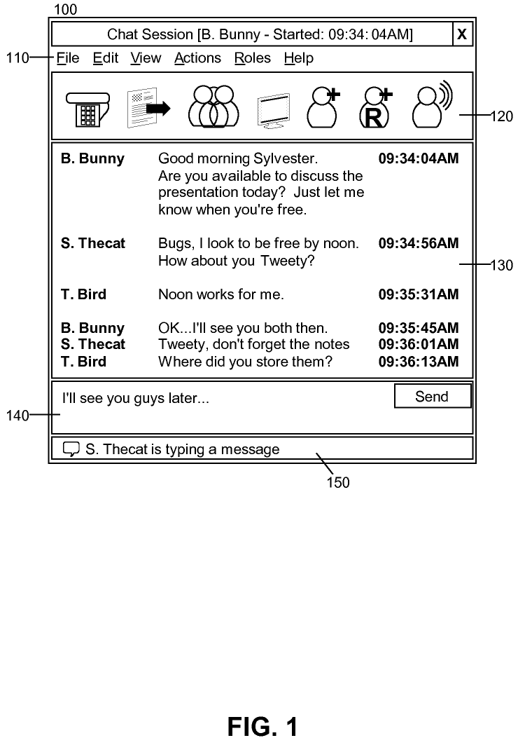

In further illustration, FIG. 1 is a pictorial illustration of a chat system user interface configured for role-based chats. The chat system user interface can include a chat session view 100 including a menu bar 110, a tool bar 120, a chat transcript 130, a message entry field 140 and a status bar 150. The chat session view 100 can provide a view to an ongoing chat between two or more collaborators and the chat transcript 130 can provide a view to the content of the ongoing chat. Additionally, the status bar can indicate the status of the ongoing chat and the message entry field 140 can provide a text entry space for posting a message to the ongoing chat.

Importantly, the tool bar 120 can include not only an icon configured to initiate the addition of a new collaborator to the ongoing chat, but also another icon configured to initiate the addition of a role to the ongoing chat in lieu of specifying a particular collaborator. In this regard, one or more roles can be defined through the roles entry in the menu bar 110. The role can defined without specifying a corresponding collaborator, or the role can be defined to correspond to a particular collaborator or group of collaborators. Optionally, the role can be defined to correspond to the collaborator creating the role.

The roles entry in the menu bar 110 also can be used to edit a role in order to assign a collaborator or group of collaborators to the role. Additionally, the roles entry in the menu bar 110 can be used to establish privileges for other collaborators to assign an associated role to a collaborator or group of collaborators. Notably, one or more routing rules can be established for a group of collaborators assigned to a role. The routing rules can specify which of the collaborators in the group are to be dynamically associated with a role at a time of a chat request for the role.

For instance, the routing rules can dynamically select a collaborator for assignment to a role according to the availability of a collaborator, or an elapsed period of time since a collaborator has last engaged in a chat. The routing rules also can dynamically select a collaborator for assignment to a role according to the context of the chat requester including location, domain, network address and the like. The routing rules further can dynamically select a collaborator for assignment to a role according to the time of day, day of week, month of year, quarter of year and such. Finally, the routing rules also can dynamically select a collaborator for assignment to a role according to delegation by another collaborator in the group.

Of further note, one or more scheduling rules can be established for a group of collaborators assigned to a role. The scheduling rules can specify which of the collaborators in the group are to be dynamically associated with a role based upon the time of a chat request for the role. Of final note, the role can be incorporated in a buddy list and presence awareness can be applied to the role to display the status of the role, including whether or not the role has been assigned and is available. Additionally, inquiring users can determine from the display of the role the number of collaborators available for assignment to the role, and an anticipated wait time for receiving a dynamic assignment of the role to an available collaborator. Finally, inquiring users can determine from the display of the role the name or identification of a collaborator assigned to the role.

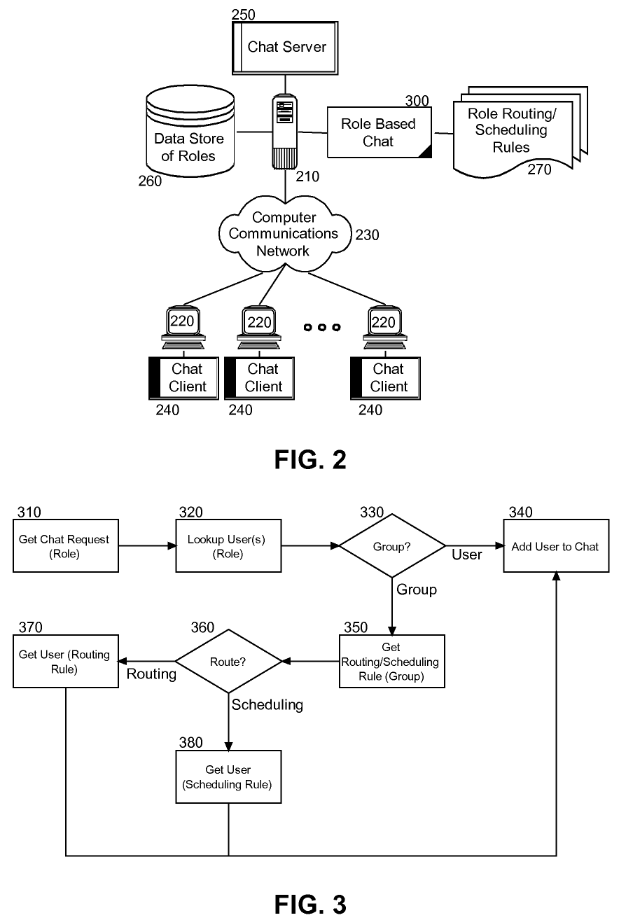

Turning now to FIG. 2, a schematic illustration is shown of a chat data processing system configured for role-based chats. The system can include a host computing platform 210 coupled to one or more computing clients 220 over computer communications network 230. The host computing platform 210 can support the operation of a chat server 250 configured to manage chat sessions over the computer communications network 230 between the different chat clients 240 associated with the different computing clients 220.

Notably, role based chat logic 300 can be coupled to the chat server 250. The role based chat logic 300 can include program code enabled to establish different roles in a data store of roles 260. The role based chat logic 300 further can include program code enabled to define one or more role routing/scheduling rules 270 for different groups of collaborators corresponding to a defined role in the data store of roles 260. Finally, the role based chat logic 300 even yet further can include program enabled to process a chat request for a role in the data store of roles 260 and to resolve the role in the request to a particular collaborator or group of collaborators. In the latter instance, the program code of the role based chat logic 300 can be enabled to select a particular one of the collaborators in the according to a pertinent rule among the role routing/scheduling rules 270.

In yet further illustration of the operation of the role based chat logic 300, FIG. 3 is a flow chart illustrating a process for role-based chats. Beginning in block 310, a chat request can be received for a role. In block 320, the user or group of users associated with the role can be identified. In decision block 330, if the role has been assigned only to a single user, in block 340 the user can be added to the chat as requested. Otherwise, in block 350 pertinent routing/scheduling rules for the role can be retrieved. In decision block 360, if the routing/scheduling rules provide for routing of the chat request for a selected collaborator, in block 370 a user can be identified according to a routing rule chat. Otherwise, in block 380 a user in the group can be selected according to schedule. In either case, the selected user can be added to the chat in block 340.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A role based chat method comprising:
dynamically specifying a role in a chat request;
resolving an assignment of the role to a collaborator in a data store of roles; and,
initiating a chat with the collaborator.

2. The method of claim 1, wherein resolving an assignment of the role to a collaborator in a data store of roles, comprises dynamically retrieving a pre-determined assignment of the collaborator to the role.

3. The method of claim 1, wherein resolving an assignment of the role to a collaborator in a data store of roles, comprises:
dynamically retrieving a pre-determined assignment of a group of collaborators to the role; and,
applying a routing rule to the group to select a particular one of the collaborators for assignment to the role.

4. The method of claim 1, wherein resolving an assignment of the role to a collaborator in a data store of roles, comprises:
dynamically retrieving a pre-determined assignment of a group of collaborators to the role;
determining one of a time and date for the chat request; and,
applying a scheduling rule to the group to select a particular one of the collaborators for assignment to the role according to the determined time and date.

5. The method of claim 1, further comprising:
inserting the role in a buddy list; and,
displaying a status for the role in the buddy list.

6. The method of claim 5, wherein displaying a status for the role in the buddy list, comprises displaying a number of collaborators in a group associated with the role who are known to be available for assignment to the role.

7. The method of claim 5, wherein displaying a status for the role in the buddy list, comprises displaying an anticipated wait time before a collaborator in a group associated with the role will be available for assignment to the role.

8. The method of claim 5, wherein displaying a status for the role in the buddy list, comprises displaying one of a name or an identifier of the user who has been assigned to the role.

9. A chat data processing system comprising:
a chat server;
a data store of roles configured to store both roles that have been assigned to collaborators registered with the chat server, and roles that have not yet been assigned to collaborators registered with the chat server; and,
role based chat logic comprising program code enabled to specify a role in a chat request, to resolve an assignment of the role to a collaborator according to the data store of roles, and to request initiation of a chat with the collaborator by the chat server.

10. The system of claim 9, further comprising role routing rules specifying which collaborator in a group of collaborators assigned to a role is to be dynamically assigned to the role.

11. The system of claim 9, further comprising role scheduling rules specifying which collaborator in a group of collaborators assigned to a role is to be dynamically assigned to the role based upon one of a time and date of the chat request.

12. A computer program product comprising a computer usable medium embodying computer usable program code for role based chat, the computer program product comprising:
computer usable program code for dynamically specifying a role in a chat request;
computer usable program code for resolving an assignment of the role to a collaborator in a data store of roles; and,
computer usable program code for initiating a chat with the collaborator.

13. The computer program product of claim 12, wherein the computer usable program code for resolving an assignment of the role to a collaborator in a data store of roles, comprises computer usable program code for dynamically retrieving a pre-determined assignment of the collaborator to the role.

14. The computer program product of claim 12, wherein the computer usable program code for resolving an assignment of the role to a collaborator in a data store of roles, comprises:
computer usable program code for dynamically retrieving a pre-determined assignment of a group of collaborators to the role; and,
computer usable program code for applying a routing rule to the group to select a particular one of the collaborators for assignment to the role.

15. The computer program product of claim 12, wherein the computer usable program code for resolving an assignment of the role to a collaborator in a data store of roles, comprises:
computer usable program code for dynamically retrieving a pre-determined assignment of a group of collaborators to the role;
computer usable program code for determining one of a time and date for the chat request; and,
computer usable program code for applying a scheduling rule to the group to select a particular one of the collaborators for assignment to the role according to the determined time and date.

16. The computer program product of claim 12, further comprising:
computer usable program code for inserting the role in a buddy list; and,
computer usable program code for displaying a status for the role in the buddy list.

17. The computer program product of claim 16, wherein the computer usable program code for displaying a status for the role in the buddy list, comprises computer usable program code for displaying a number of collaborators in a group associated with the role who are known to be available for assignment to the role.

18. The computer program product of claim 16, wherein the computer usable program code for displaying a status for the role in the buddy list, comprises computer usable program code for displaying an anticipated wait time before a collaborator in a group associated with the role will be available for assignment to the role.

19. The computer program product of claim 16, wherein the computer usable program code for displaying a status for the role in the buddy list, comprises computer usable program code for displaying one of a name or an identifier of the user who has been assigned to the role
